(19) United States
(12) Patent Application Publication
(10) Pub. No.: US 2012/0289080 A1
(43) Pub. Date: Nov. 15, 2012

(54) CABLE MODULE CAPABLE OF SIMULTANEOUSLY SUPPORTING QUICK CHARGE AND DATA TRANSMISSION OF ELECTRONIC DEVICE

(76) Inventors: Hsiu-Ling HUANG, New Taipei City (TW); Hsiao-Ting Kuan, New Taipei City (TW)

(21) Appl. No.: 13/283,068

(22) Filed: Oct. 27, 2011

(30) Foreign Application Priority Data
May 10, 2011 (TW) 100208289

(51) Int. Cl. H01R 11/00

(52) U.S. Cl. 439/502

(57) ABSTRACT

The present invention discloses a cable module capable of simultaneously supporting quick charge and data transmission of an electronic device, comprising: a USB device, which is a USB connector, and includes a circuit board and a protruding plug portion, and the circuit board has an integrated circuit and a switch electrically coupled to the circuit board, and the integrated circuit has a specification and a property for recognizing a portable electronic device which are saved in the integrated circuit, and the switch is set to at least a quick charge mode and a data transmission mode; and a cable device, with an end electrically coupled to the USB device, and the other end having an electric connector, so that the composite cable module can support quick charge and data transmission of an electronic device simultaneously, manage the electronic device effectively and provide convenient carry and use.

The present invention relates to a cable module for data transmission and quick charge, in particular to the cable module with multiple functions capable of simultaneously supporting an electric charge and a data transmission of various types of portable electronic devices.

### BACKGROUND OF THE INVENTION

Variable types of portable electronic devices such as mobile phones, MP3 players, MP4 players, flat PCs, GPS, e-Books, GPS, and digital cameras are available in the market, and these types of portable electronic devices often have the issues of power supply and data transmission. As to the power supply, these types of portable electronic device are generally charged or processed by a quick charge to obtain power supply, but present existing USB charging cables only have the quick charge function but not the data transmission function. For example, the cable used for the data transmission of a mobile phone does not have the quick charge function, due to the technical reason that the mobile phone needs to recognize and determine whether or not the charging equipment has the quick charge function, and a general quick charging cable disconnects the data transmission circuit of a cable to let the mobile phone recognize the quick charge mode and perform an electric charging. Some branded mobile phones adds a protective integrated circuit (IC) in the mobile phone to protect the mobile phone from being damaged by improper charging and recognize whether the charging cable is the designated cable, since the designated cable will enable the protective IC installed in the mobile phone to recognize the quick charge mode before the charging takes place. In existing technologies, the USB charging equipment fails to take both quick charge and data transmission function into considerations at the same time, and requires several cables of different specifications to meet the requirements. Obviously, the conventional cable causes inconvenience of use and requires improvements.

In view of the aforementioned drawbacks of the conventional electronic device with a quick charge/data transmission cable module, the inventor of the present invention conducted extensive researches and experiments, and developed a cable module capable of simultaneously supporting quick charge and data transmission functions to overcome the drawbacks of the prior art.

### SUMMARY OF THE INVENTION

Therefore, it is a primary objective of the present invention to provide a cable module capable of simultaneously supporting quick charge and data transmission of an electronic device, and the cable module can support multi-functions of a data transmission and a quick charge of various types of portable electronic devices and manage and protect the electronic device effectively, and provide convenient carry and use.

Another objective of the present invention is to provide a cable module capable of simultaneously supporting quick charge and data transmission of an electronic device, and the cable module can be used while connecting to another computer, notebook or flat PC in a data transmission mode to achieve the data transmission between the two devices or a two-way control function, so as to provide a convenient and efficient operation.

To achieve the foregoing objective, the present invention provides a cable module comprising: a universal serial bus (USB) device, being a USB connector, and including a circuit board and a protruding plug portion, and the circuit board having an integrated circuit and a switch electrically coupled to the circuit board, and the integrated circuit having a specification and a property for recognizing a portable electronic device being saved in the integrated circuit, and the switch being set to at least a quick charge mode and a data transmission mode; a cable device, with an end electrically coupled to the USB device, and the other end having an electric connector.

The technical characteristics of the present invention will become apparent with the detailed description of the preferred embodiments accompanied with the illustration of related drawings as follows.

### BRIEF DESCRIPTION OF THE DRAWINGS

FIG. 1 is a schematic view of the present invention;

FIG. 2 is a top view of the present invention;

FIG. 3 is a cross-sectional view, showing an operation of a switch in accordance with the present invention;

FIG. 4 is a side view of the present invention and an integrated circuit;

FIG. 5 is a schematic block diagram showing the operating flow of an integrated circuit of the present invention; and

FIG. 6 is a flow chart of an operation of the present invention.

### DESCRIPTION OF THE PREFERRED EMBODIMENTS

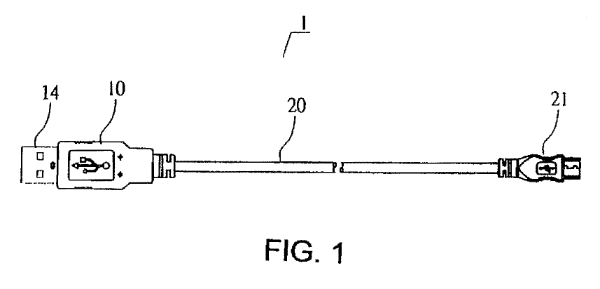

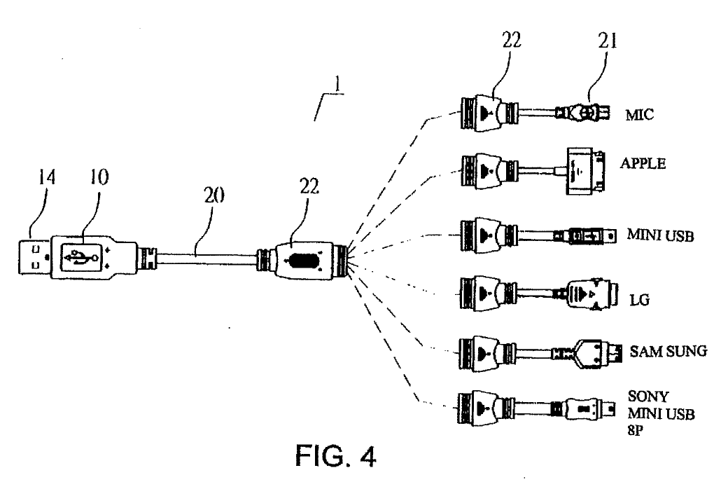

With reference to FIGS. 1, 2 and 3 for a cable module capable of simultaneously supporting quick charge and data transmission of an electronic device in accordance with the present invention, the cable module comprises a cable module 1, a USB device 10 and a cable device 20, and the USB device 10 is basically a USB connector and includes an internal circuit board 11 and a protruding plug portion 14, and the circuit board 11 is electrically coupled to an integrated circuit 12 and a switch 13, wherein the switch 13 of this preferred embodiment is a press-button switch, and the press-button switch is protruded or installed on a surface of the USB device 10 to facilitate its operation, and an end of the cable device 20 is electrically coupled to the USB device 10, and the other end of the cable device 20 has an electric connector 21 for connecting various types of electronic devices, so that the type of the electric connector 21 can be designed according to the electric connector of various types of electronic devices; or the other end of the cable device 20 has an adapter 22 (as shown in FIG. 4) provided for facilitate connecting the electric connector 21 of various types of electronic devices electric power supply or signal transmission. The cable module 1 corresponds to a charging mode of the USB2.0 (500 mA), USB3.0 (900 mA), and USB_Portcharger (1.5A).

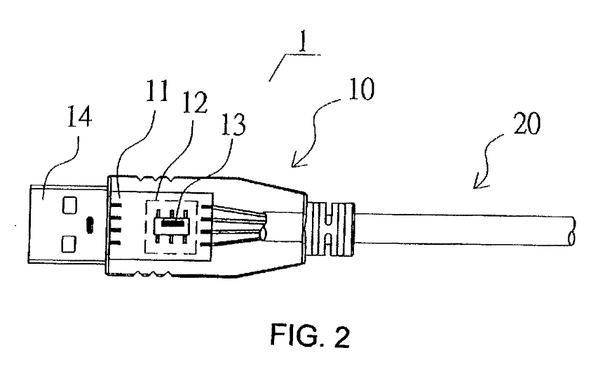

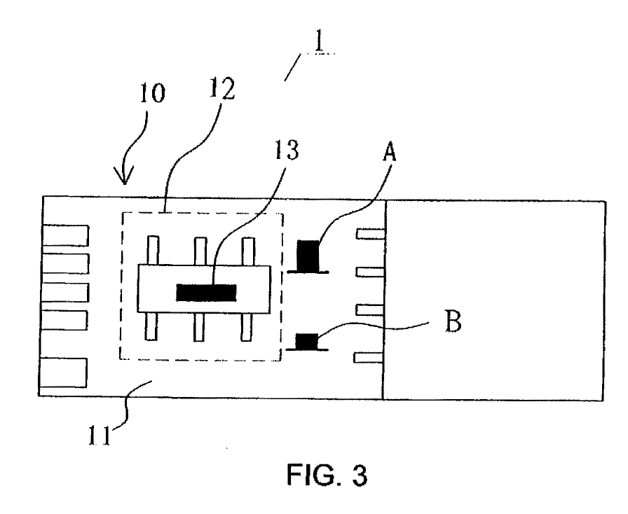

In FIGS. 2 and 3, the switch 13 of the USB device 10 is used for switching the setting of the integrated circuit such as the switch 13 situated at a status A of which the switch 13 is not pressed, but it is protruded from the surface, or the switch 13 is situated at a status B of which the switch 13 is pressed and it is compressed at a lower position. For example, the switch 13 at the status A can be set as a quick charge mode, wherein the quick charge mode refers to a charge of over 500 mA per hour, and the switch 13 at the status B can be set as a data transmission mode. Of course, the two statuses A and B can be set differently for the data transmission mode or quick charge mode as needed to achieve the composite effects of the data transmission or quick charge.

In an appropriate implementation, the switch 13 can be a switch to be switched to the quick charge mode or the data transmission mode, or the switch 13 can be a push-button switch, a toggle switch or a multiple-choice switch button, and an LED lamp of different colors can be used for indicating the selected operating mode selected by the switch, or figures or words can be printed next to the switch 13 to let user to select the mode conveniently.

When the cable module 1 of the present invention is switched to the charging mode, the specification and properties pre-stored in the integrated circuit 12 can be used for automatically recognizing various types of portable electronic devices (mobile phones, MP3 players, MP4 players, flat PCs, GPS, e-Books, GPS, digital cameras, and game players), a brand (including products of any brand, or Apple series such as iPad and iPhone), and a specification of the portable electronic device, as well as providing the correct current and voltage to perform an electric charging under the fully compatible status, so as to avoid any electric charge by a charger incompliant with the specification, manage the electric charging effectively, and protect the connected portable electronic device.

When the cable module 1 is switched to the quick charge mode, the circuit used for data transmissions have the same effects and functions of a general cable. In addition, when the cable module 1 is switched to the data transmission mode, a press button (not shown in the figure) can be provided for users to switch to a pure data transmission mode or a KM-Switch (keyboard-mouse switch) operating mode, so that a user can enter a desired function, wherein the KM-Switch operating mode is manufactured into a circuit and written into the integrated circuit 12 for switching and executing the function at a pure data transmission mode or a KM-Switch operating mode. Of course, the press button can further has a controlling end and a controlled end installed selectively. Therefore, if the cable module 1 is switched to the data transmission mode, the cable module 1 not only allows data transmissions of the electronic device (such as a mobile phone), but also allows a connection with another computer (a notebook or a flat PC), keyboard or mouse for an operation, so as to achieve the effect of transmitting data between two electronic devices, or the function of controlling an electronic device by another electronic device. The press button used for switching to a pure data transmission mode or a KM-Switch operating mode can be combined with the switch 13 in form of the aforementioned switches.

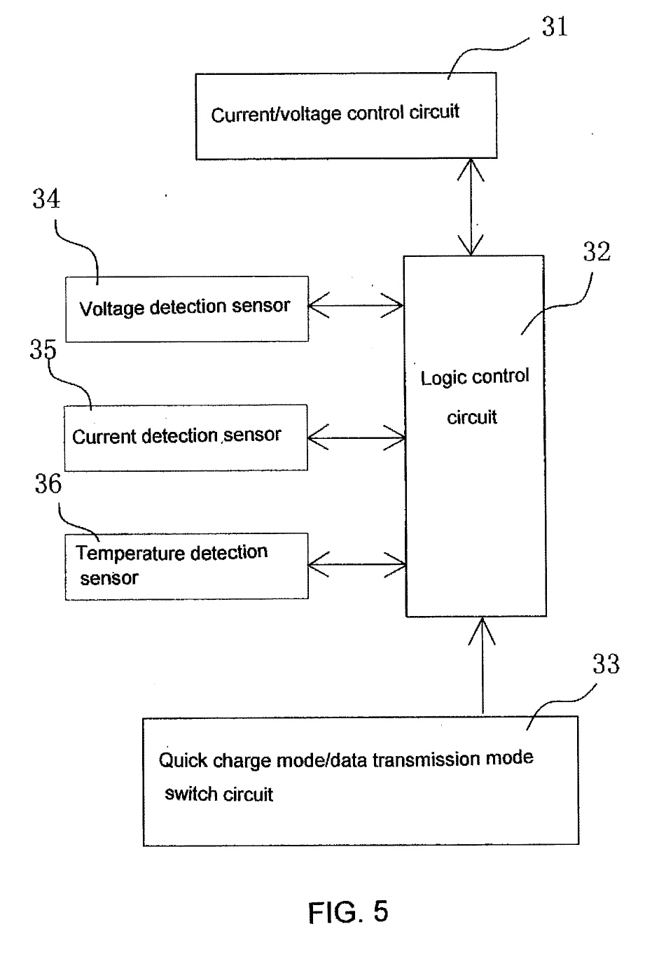

With reference to FIG. 5 for the flow chart of the operation of an integrated circuit 12 in accordance with the present invention, the integrated circuit 12 includes a current/voltage control circuit 31 and logic control circuit 32 electrically coupled to the integrated circuit 12, and the logic control circuit 32 is electrically coupled to a quick charge mode/data transmission mode switch circuit 33, a voltage detection sensor 34, a current detection sensor 35, and a temperature detection sensor 36. If an end of the cable module 1 (such as the plug portion 14) is inserted into a USB socket of a personal computer, and the other end (such as the electric connector 21) is inserted into a desired charging portable electronic device, the voltage detection sensor 34, the current detection sensor 35 and the temperature detection sensor 36 will detect the portable electronic device and input the detected results and the specification and properties including the voltage, current and temperature into the logic control circuit 32. Since the specification and properties including the voltage, the current, the temperature, the acceptable voltage and the current status have been written into the logic control circuit 32 of various different types of portable electronic devices, therefore the logic control circuit 32 can determine which brand or which specification is for the portable electronic device by performing a comparison, and the acceptable voltage and current of the portable electronic device are provided to facilitate charging the portable electronic device.

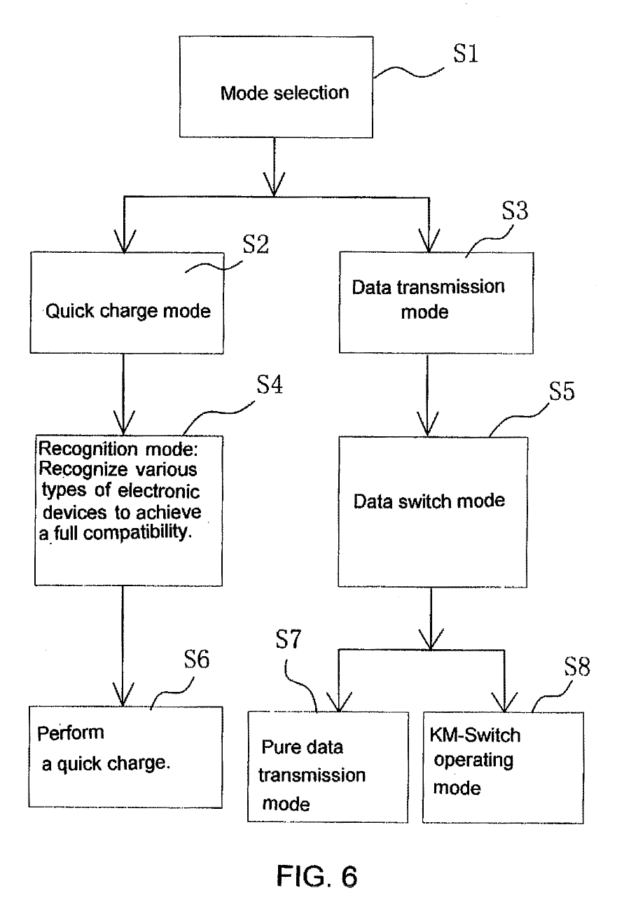

With reference to FIG. 6 for the flow chart of an operation of the present invention, the operation comprises the following steps:

(1) S1 (Mode selection): A switch 13 is provided for selecting a quick charge mode or a data transmission mode; and

(2) S2 (if the quick charge mode is selected): Enter into S4 (Recognizing the mode): An integrated circuit is provided for recognizing various types of portable electronic devices (including different branded mobile phones, MP3 players, MP4 players, flat PCs, GPS, e-Books, GPS, digital cameras, and game players), and achieving a full compatibility after the recognition is completed. The step of recognition refers to the step of recognizing the voltage, current, temperature specification, properties of various branded electronic devices. S6: Perform a quick charge; or

(3) S3 (if the data transmission mode is selected): Enter into the step of a data switching mode. S5: The switch 13 is used for selectively switching to a pure data transmission mode or a KM-Switch operating mode. As described above, the KM-Switch operating mode can further have a selection of the controlling end and the controlled end. According to S5, S7 is carried out for the data transmission mode, wherein two electronic devices are connected to transmit data with one another, or S8 is carried out for the KM-Switch operating control mode, wherein two electronic devices are connected, and one of the devices controls the other device in S8.

The present invention has the components for supporting the data transmission and electric charging functions for various different types of electronic devices and provides effective management and protection of the electronic device and convenient carry and use. The invention also can connect to another computer, notebook or flat PC in the data transmission mode, so that two devices can transmit data with each other or achieve a two-way operation and control function to provide convenient and efficient operations.

In summation of the description above, the present invention complies with patent application requirements, and is thus duly filed for patent application. While the invention has been described by means of specific embodiments, numerous modifications and variations could be made thereto by those skilled in the art without departing from the scope and spirit of the invention set forth in the claims.

What is claimed is:

1. A cable module capable of simultaneously supporting quick charge and data transmission of an electronic device, comprising:
a universal serial bus (USB) device, being a USB connector, and including a circuit board and a protruding plug portion, and the circuit board having an integrated circuit and a switch electrically coupled to the circuit board, and the integrated circuit having a specification and a property for recognizing a portable electronic device being saved in the integrated circuit, and the switch being set to at least a quick charge mode and a data transmission mode;
a cable device, with an end electrically coupled to the USB device, and the other end having an electric connector.

2. The cable module capable of simultaneously supporting quick charge and data transmission of an electronic device according to claim 1, wherein the electric connector is an adapter.

3. The cable module capable of simultaneously supporting quick charge and data transmission of an electronic device according to claim 1, wherein the switch includes a switch button, a push-button switch, a toggle switch or a multiple-choice switch button installed thereon.

4. The cable module capable of simultaneously supporting quick charge and data transmission of an electronic device according to claim 1, wherein the USB device comprises a light emitting diode (LED) lamp for indicating a selected operating mode of the switch.

5. The cable module capable of simultaneously supporting quick charge and data transmission of an electronic device according to claim 1, wherein the switch includes a switch button installed thereon, and the switch button includes at least two button status selections.

6. The cable module capable of simultaneously supporting quick charge and data transmission of an electronic device according to claim 1, wherein the data transmission mode further includes a pure data transmission mode and a keyboard-mouse switch (KM-Switch) press button.

7. The cable module capable of simultaneously supporting quick charge and data transmission of an electronic device according to claim 6, wherein the USB device further includes a press button for switching to the pure data transmission mode or the KM-Switch operating mode.

8. The cable module capable of simultaneously supporting quick charge and data transmission of an electronic device according to claim 6, wherein the KM-Switch operating mode with its operating mode is manufactured into a circuit and written into the integrated circuit.

9. The cable module capable of simultaneously supporting quick charge and data transmission of an electronic device according to claim 7, wherein the press button selectively includes a controlling end and a controlled end.

10. The cable module capable of simultaneously supporting quick charge and data transmission of an electronic device according to claim 1, wherein the integrated circuit includes a current voltage coupled to the integrated circuit for controlling the circuit and the logic control circuit.

11. The cable module capable of simultaneously supporting quick charge and data transmission of an electronic device according to claim 10, wherein the logic control circuit is further coupled to a quick charge mode/data transmission mode switch circuit.

12. The cable module capable of simultaneously supporting quick charge and data transmission of an electronic device according to claim 11, wherein the logic control circuit is further coupled to a voltage detection sensor, a current detection sensor and a temperature detection sensor.

13. The cable module capable of simultaneously supporting quick charge and data transmission of an electronic device according to claim 1, wherein the quick charge mode refers to a charge of over 500 mA per hour.
